(19) United States
(12) Patent Application Publication
(10) Pub. No.: US 2011/0278193 A1
(43) Pub. Date: Nov. 17, 2011

(54) POLYVINYLIDENE BARRIER LAYER FOR CONTAINER INTERIORS

(75) Inventors: Saeid Zerafati, Villanova, PA (US); William J. Hartzel, Cherry Hill, NJ (US)

(73) Assignee: Arkema Inc., King of Prussia, PA (US)

(21) Appl. No.: 13/146,518

(22) PCT Filed: Jan. 20, 2010
(86) PCT No.: PCT/US2010/021446

§ 371 Date: Jul. 27, 2011

Related U.S. Application Data
(60) Provisional application No. 61/147,571, filed on Jan. 27, 2009.

(51) Int. Cl. B65D 90/02; B32B 27/08; B32B 1/02

(52) U.S. Cl. 206/524.6; 428/35.7

(57) ABSTRACT

The invention relates to containers having a thin layer of polyvinylidene fluoride polymer or copolymer on its inner and/or outer surface. The polyvinylidene fluoride layer acts as a barrier layer in reducing or preventing the migration of chemicals from thermoplastic or thermoset polymeric containers into the contents of the container. This is especially applicable for containers in the food, biotech and pharmaceutical industries, as well as for toxic or corrosive materials.

### FIELD OF THE INVENTION

The invention relates to containers having a thin layer of polyvinylidene fluoride polymer or copolymer on its inner and/or outer surface. The polyvinylidene fluoride layer acts as a barrier layer in reducing or preventing the migration of chemicals from thermoplastic or thermoset polymeric containers into the contents of the container. This is especially applicable for containers in the food, biotech and pharmaceutical industries, as well as for toxic or corrosive materials.

### BACKGROUND OF THE INVENTION

Concern has been raised recently regarding residual bisphenol-A migrating from a polycarbonate baby bottle into the liquid contents of the bottle—especially when the bottle is heated. The alternatives are to use glass baby bottles, or to use disposable bag liners placed inside the bottles. Glass bottles are heavy, and are breakable—presenting a safety hazard. Polymer liners would eliminate contact with polycarbonate, but these polymers themselves contain monomers, oligomers and additives that can also leach into the milk or other liquid, and these leachables may themselves present a health concern.

In the pharmaceutical industry and biotech industries, serum and other biological fluids are most often stored in glass containers. These glass containers provide a sterile environment for transport of the fluids. However, glass is heavy, and breakage can result in the loss of valuable contents—and even result in a biohazard. Polymer containers can provide a lighter, non-breakable solution. Unfortunately, most polymers contain monomers, oligomers, and fugitive additives that will migrate at low levels into the contents of a container.

US 2008-0261050 describes a multi-layer film having a polyvinylidene fluoride layer as a contact layer for fluids and gases. The film can be used as a liner for reactors, and may also be formed into a bag useful for holding biological or pharmaceutical compounds.

WO 08/05744 describes flexible tubing having a polyvinylidene fluoride inner surface, especially useful for the transfer of high purity fluids.

There is a need for a polymeric container having little or no migration of monomers, oligomers, by-products, additives, or other compounds from the container into the contents of the container, even when heated.

Applicant has found that a thin layer of polyvinylidene fluoride on the inner surface of a rigid polymeric container effectively blocks migration of fugitive components from the polymers of the container.

### SUMMARY OF THE INVENTION

The invention relates to a rigid multi-layer container having
a) a thin polyvinylidene fluoride (PVDF) contact layer; and
b) a rigid polymeric layer which form the container.

### DETAILED DESCRIPTION OF THE INVENTION

By “rigid” container, as used herein is meant a free standing structure, having essentially the same volume before and after being filled with solid, liquid or gaseous material.

By “containers” as used herein is meant a three-dimensional structure capable of holding within its boundaries a solid, liquid, and/or gaseous compound. The bottom and sides of the container are made of one or more polymeric substrate materials, and may be different, but preferably are the same. The container preferably includes a permanent or removable top, which may or may not be polymeric, and may be of the same or different chemical composition as the rest of the container. The top is generally designed to seal the container. Examples of containers include, but are not limited to bottles, syringes, vials, and pharmaceutical/biotech reactors. A container is differentiated from a tube or pipe, in that a container is designed to hold up to a given volume of a fluid or solid, while a pipe or tube is designed for a fluid to flow through the structure—entering at one open end and leaving in a different open end. Preferably, the container has a single open end, or is permanently sealed.

The containers are made of one or more rigid substrate materials, and have a thin layer of a polyvinylidene polymer on at least one surface. In a preferred embodiment the inner surface has a polyvinylidene fluoride layer. Polyvinylidene fluoride polymers have excellent chemical and permeation resistance, with extremely low or no extractables.

Polyvinylidene fluoride polymers of the invention include the homopolymer made by polymerizing vinylidene fluoride (VDF), and copolymers, terpolymers and higher polymers of vinylidene fluoride, where the vinylidene fluoride units comprise greater than 70 percent of the total weight of all the monomer units in the polymer, and more preferably, comprise greater than 75 percent of the total weight of the monomer units. Copolymers, terpolymers and higher polymers of vinylidene fluoride may be made by reacting vinylidene fluoride with one or more monomers from the group consisting of vinyl fluoride, trifluoroethene, tetrafluoroethene, one or more of partly or fully fluorinated alpha-olefins such as 3,3,3-trifluoro-1-propene, 1,2,3,3,3-pentafluoropropene, 3,3,3,4,4-pentafluoro-1-butene, and hexafluoropropene, the partly fluorinated olefin hexafluoroisobutylene, perfluorinated vinyl ethers, such as perfluoromethyl vinyl ether, perfluoroethyl vinyl ether, perfluoro-n-propyl vinyl ether, and perfluoro-2-propoxypropyl vinyl ether, fluorinated dioxoles, such as perfluoro(1,3-dioxole) and perfluoro(2,2-dimethyl-1,3-dioxole), allylic, partly fluorinated allylic, or fluorinated allylic monomers, such as 2-hydroxyethyl allyl ether or 3-aliyloxypropanediol, and ethene or propene. Preferred copolymers or terpolymers are formed with vinyl fluoride, trifluoroethene, tetrafluoroethene (TFE), and hexafluoropropene (HFP).

Preferred copolymers include those comprising from about 71 to about 99 weight percent VDF, and correspondingly from about 1 to about 29 percent TFE; from about 71 to 99 weight percent VDF, and correspondingly from about 1 to 29 percent HFP (such as disclosed in U.S. Pat. No. 3,178,399); and from about 71 to 99 weight percent VDF, and correspondingly from about 1 to 29 weight percent chlorotrifluoroethylene (CTFE).

Preferred terpolymers are the terpolymer of VDF, HFP and TFE, and the terpolymer of VDF, trifluoroethene, and TFE. Especially preferred terpolymers have at least 71 weight percent VDF, and the other comonomers may be present in varying portions, but together they comprise up to 29 weight percent of the terpolymer.

Most preferred PVDF copolymers include are those having 2 to 30 weight percent of HFP, such as KYNAR FLEX 2800, 2750 and 2500 resins (Arkema Inc.).

The thin PVDF inner layer is from 0.25 mils to 30 mils thick, preferably 0.5 mil to 10 mil and more preferably 1.0 to 4 mils thick. If the layer is too thin there is a potential for migration of extractants through the layer and potential attack from the contents to permeate through the PVDF layer and attack the other materials in the construction. Thicker layers may be used, but this adds unnecessary cost.

In one embodiment, the PVDF provides a clear layer, having a haze level for the bottle of less than 44%, and preferably less than 31% as measured by ASTM D1003 and an optical transmission of more than 87%, and preferably more than 89%. In one test the optical transmission was measured at 550+/−2 nm nm using a Perkin Elmer Lambda 850/800 UV/Vis or Lambda 19 spectrophotometer with an integrating sphere in a transmission mode. The haze was measured at the BYK Gardner Haze meter in a photopic region (550-560 nm).

The rigid container is formed of a thermoplastic or thermoset polymer, providing good mechanical properties for the container. Preferably the container is formed from polymers that have the ability to be sterilized by either steam, irradiation, or chemical means, and have excellent thermal stability, and durability. Ideally this construction would be used to replace glass and would be clear and shatter resistance.

The container polymer could be a single layer polymer, or could be a multi-layer structure. Useful polymers for the container include, but are not limited to polyurethane (PU), thermoplastic polyurethane (TPU), polyvinyl chloride (PVC), plasticized PVC, polymethylmethacrylate (PMMA) homopolymers and copolymers, polyethylene (of all densities), polybutylene, polypropylene polyamides, functional polyolefins, thermoplastic olefin (TPO), alkyl (meth)acrylate polymers and copolymers, acrylonitrile butadiene styrene (ABS) terpolymers, acrylonitrile-styrene-acrylate (ASA) terpolymer, polycarbonate (PC), polyesters, poly(butylene terephthalate), poly(ethylene terephthalate), MBS copolymers, high impact polystyrene (HIPS), acrylonitrile/acrylate copolymers, poly ethylene terephthalate (PET), acrylonitrile/methyl methacrylate copolymers, impact modified polyolefins and impact modified PVC, fluoropolymers, or mixtures thereof. An ethylene vinyl alcohol (EVOH) layer may be included in the structure as an additional barrier layer.

Since it is difficult to form a good bond between PVDF and most other polymers, a tie or adhesive layers may be used between the PVDF layer and container material.

The PVDF layer can be added to the inside and/or outside of the container in many ways, and the choice can depend on the means by which the container is manufactured. In one embodiment, the PVDF layer can be coextruded with the container polymer (and optional tie layer) to form a multi-layer extrudate—having 2 or more different layers. The extrudate can be formed into the final container by operations such as, but not limited to, blow molding. The co-extrudate could also be in the form of a tube or pipe, which can be cut and sealed (welded) into a container. A multi-shot injection molding could also be used. Alternately, the PVDF layer could also be separately formed, and laminated onto the substrate polymer.

In one embodiment, the PVDF layer can be coated onto the container polymer substrate by a spray, roller, inject, dip, spin coating, brushing, dipping, or other process. In this case the PVDF can be in the form of an aqueous or solvent solution that forms a coating on one or more surfaces of a container.

In another embodiment contemplated by the invention, the PVDF layer could be a separate/removable layer, such as a liner for a baby bottle. The liner could be removed, discarded, and replaced with a new liner, allowing reuse of the container.

In one embodiment, a three-layer container is made having a thin PVDF layer, a PMMA tie layer, and a plasticized PVC outer layer. The container could be coextruded or generated by a lamination process and welded into a container in a secondary step. The container could also be made by extrusion blow molding.

In another preferred embodiment, a container or bottle is formed having a thin layer of PVDF on the inside, a PMMA tie layer and PC on the outside. The container could be made using a multi-layer blown film process. This construction can also be made by two shot injection molding without the use of a tie layer. The PC would be the body of the bottle and PVDF would entirely coat the inner side of the PC. The container is useful for baby bottles currently made with a single PC layer. PC typically contains oligomers, monomers and other leachables, the leaching increasing with the heating of the bottle. The composition of the invention allows for heating of the contents of the bottle without leachables, and could allow for reconstitution of the baby formula directly in the bottle. In one embodiment, bottles were made by a multilayer blow molding operation having the structure PVDF/PMMA/PC/PMMA/PVDF, and found to exhibit good optical and mechanical properties.

The whole container or its parts could be manufactured through an injection molding overmolding process. In this process, a film of PVDF is installed in the mold followed by a film of PMMA and then PC is injected into the cavity after the mold is closed. The heat from the injection molded PC would melt the PMMA to form a tie layer between the PC and PVDF layers and produce a part that has a thin layer of Kynar on one side and PC on the other with a tie layer of PMMA. In a variation, a single multi-layer film of PVDF/PMMA could be used in the in-mold process. This multi-layered film could be formed through thermoforming of similar processes to shape it in the form of the injection molding cavity before insertion in the mold. The preferred thickness of the PVDF and PMMA films is between 1 to 10 mils each. There are other similar techniques for overmolding known to those in the art.

One of ordinary skill in the art could imagine many applications and constructions for containers having the PVDF inside layer of the invention, based on the specification and examples provided. The PVDF in the sample structures listed below can indicate a homopolymer of copolymer of PVDF. While not being limited to any specific construction, several useful container examples include:
PVDF/PU
PVDF/PMMA/plasticized PVC
PVDF/PMMA/PVC
PVDF/KYNAR ADX/PU (KYNAR ADX is a maleic anhydride-grafted PVDF made by Arkema)
PVDF/PMMA/PC
PVDF/PU/PVC
PVDF/KYNAR ADX/LOTADER/PE (LOTADER is a reactive polyethylene having either glygidyl methacrylate or maleic anhydride groups, from Arkema Inc.)
PVDF/KYNAR ADX PVDF/Filled PVDF PVDF/PVDF copolymer
PVDF/KYNAR ADX/EVOH/Nylon
PVDF/KYNAR ADX/EVOH/OREVAC/PE
KYNAR/KYNAR ADX/TPU+PVC
PVDF/KYNAR ADX/rubber
PVDF/PVDF copolymer/rubber
PVDF/Silicone
PVDF/PC/PVDF−Encapsulate
PVDF/PET/PVDF−Encapsulate
PVDF/TPU/EVOH/TPU/PVDF
PVDF/PMMA/PC/PMMA/PVDF
PVDF/PMMA/PVC/PMMA/PVDF
PVDF/PU/PVC/PU/PVDF

By “encapsulate” as used in the examples above is meant that there is no tie layer between the PVDF and the PC or PE. While there may not be strong adhesion between the layers, the layers would not separate in the formed container as they are of the same integral shape.

The PVDF-layered containers of the invention can reduce or eliminate leaching of monomer, oligomer, plasticizer, and other additives (such as UV stabilizers, colorants, dyes, etc), into the contents of the container. These containers are especially effective when the contents of the container are meant to enter a living organism, either as food, or directly. The container of the invention also prevents permeation of oxygen into the container

The PVDF-layer container also prevents materials from the inside of the container from permeating out of the container, which is especially useful for containers holding toxic or corrosive materials, such as, but not limited to, acids, bases, solvent, and halogenated materials. The materials inside the container may be solids, liquids or gasses.

### Example 1

A three layer bottle with the following structure was manufacture through blow molding process:

Inner layer
KYNAR PVDF
PMMA
PC
Outer layer

The materials used were KYNAR 2800-20 (PVDF/HFP) from ARKEMA, LEXAN PK2870 (PC) from GE and PLEXIGLAS P600 acrylic copolymer from Arkema Inc. The resulted 12 Oz (ketchup) bottles had a layer thickness as follows:

| | Thickness/μm | Thickness/μm | Thickness/μm |
|---|---|---|---|
| | Inner layer, | 2^{nd} layer, | Outer layer, |
| Sample | KYNAR 2800-20 | PLEXIGLAS P600 | Lexan PK2870 |
| 1 | 120 | 150 | 870 |

The multilayer structure formed contained no visible flaws. The resulting bottle had a haze level of 32.1% and light transmission of 88.6%. Bottles were run successfully through Federal registry testing standard for drop test using method 178.603. Also, the bottles were run through an autoclave cycle 3 three times without delamination or other noticeable physical problems.

### Example 2

The procedure of Example 1 was repeated, using KYNAR 720 (PVDF homopolymer) producing the following results:

| | Thickness/μm | Thickness/μm | Thickness/μm |
|---|---|---|---|
| | Inner layer, | 2^{nd} layer, | Outer layer, |
| Sample | KYNAR 720 | PLEXIGLAS P600 | LEXAN PK2870 |
| 2 | 120 | 150 | 870 |

The multilayer structure formed contained no visible flaws. The resulting bottle had a haze level of 43.1% and light transmission of 87.3%. Bottles were run successfully through Federal registry testing standard for drop test using method 178.603. Also, the bottles were run through an autoclave cycle 3 three times without delamination or other noticeable physical problems.

These bottles were filled with hydrochloric acid and observed for 48 days without any change in properties.

### Example 3

A five layer bottle with the following structure was manufactured by a blow molding process.

KYNAR PVDF
PMMA
PC
PMMA
KYNAR PVDF

The materials used were KYNAR 2800-20 from Arkema Inc., LEXAN PK2870 from GE and PLEXIGLAS DR-101 Acrylic from Arkema. The resulting 12 Oz (ketchup) bottles had a layer thickness as follows:

| | Thickness/ | Thickness/ | | Thickness/ | Thickness/ |
|---|---|---|---|---|---|
| | μm | μm | Thickness/ | μm | μm |
| | Inner | 2^{nd} layer, | μm | 4^{th} layer, | Outer |
| | layer, | PLEXIGLAS | 3^{rd} layer, | PLEXIGLAS | layer, |
| | KYNAR | DR-101 | LEXAN | DR-101 | KYNAR |
| Sample | 2800-20 | Acrylic | PK2870 | Acrylic | 2800-20 |
| 3 | 130 | 15 | 590 | 25 | 90 |

The process was successful and the multilayer structure had no visible flaws. The resulted bottle had a haze level of 36.3% and light transmission of 89.5%. Bottles were run successfully through Federal registry testing standard for drop test using method 178.603. Also, the bottles were run through an autoclave cycle 3 three times without delamination or other physical problems.
The bottles were filled with toluene and observed for 25 days without any major change in physical behavior.

What is claimed is:

1. A rigid multi-layer container comprising:
c) a thin polyvinylidene fluoride (PVDF) contact layer; and
d) a rigid polymeric layer
which form the container

2. The rigid container of claim 1 having a inner PVDF layer in contact with the contents of the container.

3. The rigid container of claim 1, wherein said container further comprises a tie layer between the PVDF layer and the rigid polymeric layer.

4. The rigid container of claim 1, wherein said rigid polymeric outer layer comprises two or more layers that are adjacent to, and adhering to each other.

5. The rigid container of claim 1, wherein said PVDF layer has a thickness of from 0.25 to 30 mils.

6. The rigid container of claim 1, wherein said PVDF layer is a PVDF homopolymer or copolymer with less than 10% HFP.

7. The rigid container of claim 1, wherein said container is formed by a blow co-extrusion process.

8. The rigid container of claim 1, wherein said container is formed by an in-mold lamination or over-molding process.

9. The rigid container of claim 1, wherein said container is formed by a dual injection molding.

10. The rigid container of claim 2, wherein the contents comprise a food, biopharma material, acid, base, solvent or halogenated material.

11. The rigid container of claim 1, wherein said rigid polymeric layer is selected from the group consisting of polyurethane (PU), thermoplastic polyurethane (TPU), polyvinyl chloride (PVC), plasticized PVC, polymethylmethacrylate (PMMA) homopolymers and copolymers, polyethylene (of all densities), polybutylene, polypropylene polyamides, functional polyolefins, thermoplastic olefin (TPO), alkyl (meth)acrylate polymers and copolymers, acrylonitrile butadiene styrene (ABS) terpolymers, acrylonitrile-styrene-acrylate (ASA) terpolymer, polycarbonate (PC), polyesters, poly(butylene terephthalate), poly(ethylene terephthalate), MBS copolymers, high impact polystyrene (HIPS), acrylonitrile/acrylate copolymers, poly ethylene terephthalate (PET), acrylonitrile/methyl methacrylate copolymers, impact modified polyolefins and impact modified PVC, fluoropolymers, or mixtures thereof, or mixtures thereof.

12. The rigid container of claim 1 consisting of an inner PVDF layer, a PMMA (homopolymer or copolymer) tie layer, and a PC outer layer.
